(19) United States
(12) Patent Application Publication
(10) Pub. No.: US 2007/0219097 A1
(43) Pub. Date: Sep. 20, 2007

(54) Emulsifiers For Drilling Fluids

(76) Inventors: Heinz Müeller, Monheim (DE); Nadja Herzog, Korschenbroich (DE); Ansgar Behler, Bottrop (DE); Jens Hartmann, Bidnija (MT)

Correspondence Address: COGNIS CORPORATION;PATENT DEPARTMENT, 300 BROOKSIDE AVENUE, AMBLER, PA, 19002, US

(21) Appl. No.: 10/576,916

(22) PCT Filed: Oct. 15, 2004
(86) PCT No.: PCT/EP04/11624

§ 371 Date: Mar. 27, 2007

(30) Foreign Application Priority Data
Oct. 24, 2003 (DE) 103 49 808.7

(51) Int. Cl. C09K 8/08

(52) U.S. Cl. 507/110; 507/211

(57) ABSTRACT

The invention relates to use of surfactant mixtures in drilling fluids, the mixtures are produced by reacting an aqueous solution of at least one alkyl oligoglycoside and/or alkenyl oligoglycoside with an omega haloacid, or its salts or esters in the presence of an alkali. The mixtures are suitable for use as emulsifiers for invert drilling-fluid systems and improve the filtration characteristics of the systems.

This invention relates generally to additives for well servicing compositions and, more particularly, to emulsifiers for water-based emulsion drilling fluids and to drilling fluid systems containing these emulsifiers.

It is known that drilling fluids for sinking wells in rock and bringing up the rock cuttings are flowable water- or oil-based systems that are thickened to a limited extent. Oil-based systems are acquiring increasing significance in practice and are used in particular in offshore drilling operations. Oil-based drilling fluids are generally used as so-called invert emulsion muds which consist of a 3-phase system: oil, water and fine-particle solids. Drilling fluids such as these are preparations of the w/o emulsion type, i.e. the aqueous phase is heterogeneously and finely dispersed in the continuous oil phase. A range of additives may be used for stabilizing the system as a whole and for establishing the required performance properties, including in particular emulsifiers and emulsifier systems, weighting agents, fluid loss additives, viscosity adjusters and optionally an alkali reserve.

A key criterion for evaluating the usefulness of invert drilling fluids in practice are their rheological characteristics. Certain viscosity values have to be maintained in drilling fluid systems suitable for practical application. In particular, uncontrolled thickening and hence increases in the viscosity of the drilling fluid have to be strictly prevented because, otherwise, the pipe can become stuck during drilling and can only be freed by expensive, time-consuming measures. In practice, therefore, suitable diluents are added to the drilling fluid systems before and also during drilling. It is known that anionic surfactants from the group of fatty alcohol sulfates, fatty alcohol ether sulfates and alkyl benzenesulfonates are preferably used for this purpose. In addition, it is important to ensure that the drilling fluid which is pumped into the ground is heated, for example, to temperatures of 150 to 250° F. (66 or 121° C.), depending on the depth, and—in the case of very deep wells—to temperatures of up to 350° F. (178° C.), although it is not always desirable for the rheology of the drilling fluid at high temperatures to be influenced at the same time. Instead, only selective influencing in the critical low temperature range is desirable in many cases. In addition, all additives and auxiliaries used in offshore and onshore drilling fluid systems are expected to satisfy stringent biodegradability and toxicity requirements. Also, the ambient conditions prevailing during drilling operations, such as high temperatures, high pressures, changes in pH caused by the inrush of acidic gases, etc., impose high demands on the choice of possible components and additives.

If water-based drilling fluid systems in emulsion form are used, as is often the case, the presence of emulsifiers is essential. A large number of suitable compounds are known to the expert, for example from the disclosure of EP 0 948 577, of which the technical teaching is confined to special temperature-dependent emulsions. However, a large number of emulsifiers suitable for use in drilling fluids are mentioned in that document, cf. the disclosure of paragraphs 0066 to 0076 of EP 0 948 577 B1. The choice of emulsifiers for well servicing systems and, more particularly, drilling fluids is primarily directed at finding substances which lead to maximum stability of the emulsion, even under the extreme conditions of practical application, i.e. an increase in the viscosity of the drilling fluid and, more particularly, breaking of the emulsion should be strictly prevented. This applies in particular to emulsions of the water-in-oil type.

In addition, a key function of the drilling fluid is to stabilize the cavity formed by drilling against the inrush of liquids from the formation. This is achieved by the pressure of the fluid being greater than the pressure of the formation liquids. However, the drilling fluid thus also tends to penetrate into the formation, although solids present in the fluid rapidly form a layer (so-called filter cake) on the surface of the bore wall which only allows small quantities of liquid through. The quantity of liquid thus lost should be kept to a minimum, so that the filtrate volume (as measured to API) is a key criterion for the quality of a drilling fluid. Accordingly, there is an ongoing search for systems which improve the filtrate values of drilling fluids without adversely affecting the other properties demanded of them.

It has now been found that the problem stated above can be solved by the use of certain sugar derivatives.

Accordingly, the present invention relates to the use of surfactant mixtures produced by reacting an aqueous solution of at least one alkyl and/or alkenyl oligoglycoside with an omega-helocarboxylic acid or salts or esters thereof in the presence of alkali in drilling fluids.

The surfactant mixtures according to the invention are produced using alkyl and alkenyl oligoglycosides corresponding to formula (I):
RO-[G]ₚ (I)
in which R is an alkyl and/or alkenyl group containing 4 to 22 carbon atoms, G is a sugar unit containing 5 or 6 carbon atoms and p is a number of 1 to 10. They may be obtained by the relevant methods of preparative organic chemistry. The alkyl and/or alkenyl oligoglycosides may be derived from aldoses or ketoses containing 5 or 6 carbon atoms, preferably glucose. Accordingly, the preferred alkyl and/or alkenyl oligoglycosides are alkyl and/or alkenyl oligoglucosides. The index p in general formula (I) indicates the degree of oligomerization (DP), i.e. the distribution of mono- and oligoglycosides, and is a number of 1 to 10. Whereas p in a given compound must always be an integer and, above all, may assume a value of 1 to 6, the value p for a certain alkyl oligoglycoside is an analytically determined calculated quantity which is generally a broken number. Alkyl and/or alkenyl oligoglycosides having an average degree of oligomerization p of 1.1 to 3.0 are preferably used. Alkyl and/or alkenyl oligoglycosides having a degree of oligomerization of less than 1.7 and, more particularly, between 1.2 and 1.4 are preferred from the applicational perspective. The alkyl or alkenyl group R¹ may be derived from primary alcohols containing 4 to 11 and preferably 8 to 10 carbon atoms. Typical examples are butanol, caproic alcohol, caprylic alcohol, capric alcohol and undecyl alcohol and the technical mixtures thereof obtained, for example, in the hydrogenation of technical fatty acid methyl esters or in the hydrogenation of aldehydes from Roelen's oxosynthesis. Alkyl oligoglucosides having a chain length of C₈ to C₁₀ (DP=1 to 3), which are obtained as first runnings in the separation of technical C₈₋₁₈ coconut oil fatty alcohol by distillation and which may contain less than 6% by weight of C₁₋₂ alcohol as an impurity, and also alkyl oligoglucosides based on technical C_{9/11} oxoalcohols (DP=1 to 3) are preferred. In addition, the alkyl or alkenyl group R¹ may also be derived from primary alcohols containing 12 to 22, preferably 12 to 18 and more particularly 12 to 14 carbon atoms. Typical examples are lauryl alcohol, myristyl alcohol, cetyl alcohol, palmitoleyl alcohol, stearyl alcohol, isostearyl alcohol, oleyl alcohol, elaidyl alcohol, petroselinyl alcohol, arachyl alcohol, gadoleyl alcohol, behenyl alcohol, erucyl alcohol, brassidyl alcohol and technical mixtures thereof which may be obtained as described above. Alkyl oligoglucosides based on hydrogenated C_{12/14} coconut oil fatty alcohol having a DP of 1 to 3 are preferred. The surfactant mixtures according to the invention are produced using omega-halocarboxylic acids or salts or esters thereof. Omega-halocarboxylic acids, salts or esters suitable for the purposes of the invention are any compounds of this type known to the expert from the literature. Potassium or sodium monochloroacetate (MCA) is preferably used. The production process and the mixtures themselves are the subject of DE 101 22 255 C1, cf. in particular column 2, paragraph 0009 to column 3, paragraph 0011 and Examples 1 and 2 of that document. Preferred mixtures contain APG carboxylates according to DE 101 22 255 C1, a molar ratio of APG to omega-halocarboxylic acids of 1:0.5 to 1:3.5 and more particularly 1:1 to 1:1.5 being maintained during their production.

The surfactant mixtures according to the present technical teaching are present as aqueous solutions which contain a carboxylate of the APG used as their principal constituent, i.e. at least 15% by weight of that carboxylate. The water-based compositions also contain small quantities, i.e. less than 15% by weight and preferably less than 12% by weight, of unreacted APG. Glycol and salts, such as NaCl, may also be present in quantities of 5 to 1% by weight each. The remainder is water. A typical composition contains 50 to 70% by weight water, 15 to 20% by weight of an APG carboxylate according to DE 101 22 255 C1, 5 to 15% by weight APG and 1 to 5% by weight each of salts and glycol.

The surfactant mixtures are preferably used as emulsifiers in drilling fluids, the drilling fluid having to contain at least one aqueous and one non-aqueous phase. In a particularly preferred embodiment, the surfactant mixtures are used as emulsifiers in drilling fluids which form a water-in-oil or oil-in-water emulsion. In a most particularly preferred embodiment, the surfactant mixtures are used for so-called invert drilling fluids where a water phase is “dispersely” emulsified in a continuous oil phase. It can be of advantage to use the surfactant mixtures according to the invention in such drilling fluids, in which case the oil phase of the drilling fluids is selected from esters of saturated or unsaturated, branched or unbranched monocarboxylic acids containing 1 to 24 carbon atoms and monohydric, linear or branched, saturated or unsaturated alcohols containing 1 to 24 carbon atoms. The surfactant mixtures are also preferably used in drilling fluids of which the oil phase contains linear α-olefins, internal olefins or paraffins. It can also be of advantage to use oil phases consisting of mixtures of the preferred carrier fluids described above.

The drilling fluids according to the invention should contain the surfactant mixtures in quantities of preferably at least 0.05% by weight, based on the total weight of the drilling fluid. In a preferred embodiment, the surfactant mixtures are used in quantities of 0.1 to at most 25% by weight, preferably 0.1 to 10% by weight and more particularly 0.1 to 5% by weight, based on the weight of the drilling fluid as a whole, in order to be able optimally to develop their effect according to the invention. The range from 0.1 to 1.0% by weight is most particularly preferred. Based on the weight of the oil phase alone, the surfactant mixtures should preferably be used in a quantity of 1 to 15% by weight, the range from 1 to 10% by weight being particularly preferred,

The use of the surfactant mixtures according to the invention leads to an improvement in the rheological properties of the emulsions, particularly in the presence of seawater. The filtrate properties of corresponding drilling fluids are also clearly improved by addition of the surfactant mixtures according to the invention. Another positive effect of using the surfactant mixtures in drilling fluids is that the drilling fluids retain their rheological properties, even in the event of contamination, and do not, for example, undergo an unfavorable increase in yield point. This is another aspect of the positive effect, particularly in the case of invert drilling fluid systems contaminated with solids and/or seawater.

In a preferred embodiment, free, saturated or unsaturated fatty acids with the general formula R—COOH, in which R represents C₅₋₂₁ alkyl or alkenyl groups, are used in addition to the surfactant mixtures according to the invention. These fatty acids should be present in quantities of at least 0.1% by weight, preferably at least 0.3% by weight and advantageously in the range from 0.5 to 10% by weight, based on the weight of the drilling fluid. A particularly preferred range is from 1.0 to 5.0% by weight. Based on the weight of the oil phase, the free fatty acids should preferably be used in quantities of 1.5 to 6% by weight. In another preferred embodiment, the free fatty acids are used in a ratio by weight of ca. 1:1, preferably 2:1, to at most 10:1 to the surfactant mixtures.

The present invention also relates to well servicing compositions, more particularly drilling fluids, flowable and pumpable at 5 to 20° C. which are based either on a continuous oil phase, optionally in admixture with a limited quantity of a disperse aqueous phase (w/o invert type), or on an o/w emulsion with a disperse oil phase in the continuous aqueous phase and which optionally contain dissolved and/or dispersed standard auxiliaries, such as thickeners, emulsifiers, fluid loss additives, wetting agents, fine-particle weighting agents, salts, alkali reserves and/or biocides, characterized in that, in their oil phase, they contain compounds selected from the following classes:
(a) carboxylic acid esters corresponding to formula (II):
   R′—COO—R″ (II)
where R′ is a saturated or unsaturated, linear or branched C₅₋₂₃ alkyl group and R″ is a C₁₋₂₂ alkyl group which may be saturated or unsaturated, linear or branched,
(b) linear or branched C₈₋₃₀ olefins,
(c) water-insoluble, symmetrical or nonsymmetrical ethers of monohydric alcohols of natural or synthetic origin which may contain 1 to 24 carbon atoms,
(d) water-insoluble alcohols corresponding to formula (III):
   R′″—OH (III)
where R′″ is a saturated, unsaturated, linear or branched C₈₋₂₄ alkyl group,
(e) carbonic acid diesters,
(f) paraffins,
(g) acetals.

These compositions contain oils from the above-mentioned groups either individually or in the form of mixtures with one another in the continuous oil phase.

In a particularly preferred embodiment, the oil phase is formed by the carboxylic acid esters of formula (II), more particularly those described in EP 0 374 672 or EP 0 386 636. In another particularly preferred embodiment, the compounds of formula (I) are used in invert drilling fluid emulsions of which the oil phase (A) contains esters of formula (II), in which R′ is an alkyl group containing 5 to 21 carbon atoms, preferably 5 to 17 carbon atoms and more particularly 11 to 17 carbon atoms. Particularly suitable alcohols in such esters are based on branched or unbranched alcohols containing 1 to 8 carbon atoms, for example on methanol, isopropanol, isobutanol or 2-ethylhexanol. Alcohols containing 12 to 18 carbon atoms are also preferred. Particularly preferred esters are saturated C₁₂₋₁₄ fatty acid esters or unsaturated C₁₆₋₁₈ fatty acids with isopropyl, isobutyl or 2-ethylhexanol as the alcohol component. 2-Ethylhexyl octanoate is also suitable. Other suitable esters are acetic acid esters, particularly acetates of C₈₋₁₈ fatty alcohols. Oil phases such as these—normally called carrier fluids—are known, for example, from earlier Cognis patents/patent applications, cf. in particular European patent applications EP 0 374 671, EP 0 374 672, EP 0 382 070, EP 0 386 638. Oil phases based on linear olefins are also known to the expert, cf. EP-A-0 765 368. Branched esters (a) as disclosed, for example in WO 99/33932 (Chevron) or in EP 0 642 561 (Exxon) are also suitable carrier fluids in the process according to the invention; the esters disclosed therein are part of the disclosure of the present invention. Mixtures of these preferred esters with one another are also preferred. In another preferred embodiment, the oil phase contains α-olefins or internal olefins (IOs) or poly-α-olefins (PAOS) as component (b). The IOs or IO mixtures present in the oil phase according to the invention then contain corresponding compounds with 12 to 30 carbon atoms in the molecule, preferably 14 to 24 carbon atoms and more particularly up to 20 carbon atoms in the molecule. If α-olefins are present as the oil phase, α-olefins based on fatty acids containing 12 to 18 carbon atoms are preferably used, saturated α-olefins being particularly preferred. These preferred mixtures are the subject of applicants' EP 0 765 368 A1.

Other suitable constituents of the oil phase are water-insoluble symmetrical or nonsymmetrical ethers (c) of monohydric alcohols of natural or synthetic origin, the alcohols containing from 1 to 24 carbon atoms. Corresponding drilling fluids are the subject of European patent application EP 0 472 557. Water-soluble alcohols of group (d) can also be preferred constituents of the oil phase. The same applies to carbonic acid diesters (e) according to European patent application EP 0 532 570. These compounds can make up the oil phase as a whole or parts thereof. Paraffins (f) and/or acetals (g) may also be used as constituents of the oil phase.

Mixtures of compounds (a) to (g) with one another may also be used. In a preferred embodiment, at least 50% by weight of the oil phase of the emulsions according to the invention consists of such preferred compounds (a) to (g), systems in which 60 to 80% and more particularly 100% by weight of the oil phase consists of compounds (a) to (g) or mixtures thereof being particularly preferred.

The oil phases themselves then preferably have flash points above 85° C. and preferably above 100° C. They are formulated in particular as invert drilling fluids of the w/o type and preferably contain the disperse aqueous phase in quantities of about 5. In water-based o/w emulsion fluids, the quantity of disperse oil phase is in the range from about 1 to 50% by weight and preferably in the range from about 8 to 50% by weight. The continuous oil phases of such drilling fluids according to the invention have a Brookfield (RVT) viscosity at 0 to 5° C. of below 50 mPa·s and preferably not above 40 mPa·s. The pH of the fluids is preferably adjusted to a value in the range from about neutral to moderately basic and, more particularly, to a value in the range from about 7.5 to 11; the use of lime as an alkali reserve can be particularly preferred.

Water is also a constituent of the described drilling fluids. The water is preferably present in the invert emulsions in quantities of at least about 0.5% by weight. In a preferred embodiment, however, the invert emulsions contain at least 5 to 10% by weight of water. The water in drilling fluid systems of the type described herein always contains quantities of electrolytes to equalize the osmotic gradient between the drilling fluid and the formation water, calcium and/or sodium salts representing the preferred electrolytes. CaCl₂ in particular is commonly used. However, other salts from the group of alkali metals and/or alkaline earth metals, for example potassium acetates and/or formates, are also suitable.

According to the invention, the surfactant mixtures are preferably used as emulsifiers in drilling fluid systems which, based on the liquid phase as a whole, contain 10 to 30% by weight water and hence 90 to 70% by weight of the oil phase. On account of the high percentage of dispersed solids in invert drilling fluids, reference is not made here to the weight of the fluid as a whole, i.e. water, oil and solid phases. The surfactant mixtures are oil-soluble and, accordingly, are predominantly present in the oil phase and the interfaces thereof with the water phase.

Other preferred mixing ratios are 80% by weight oil phase to 20% by weight water phase. The drilling fluids according to the invention may also contain other typical additives and auxiliaries such as, in particular, other emulsifiers, weighting agents, fluid loss additives, thickeners and alkali reserves, more particularly lime (═Ca(OH)₂), and also biocides and so-called wetting agents which improve the wettability of surfaces.

Emulsifiers suitable for use in practice are systems which are suitable for forming the required w/o emulsions. Selected oleophilic fatty acid salts, for example based on amidoamine compounds, are particularly suitable. Emulsifiers of the type in question here are marketed as highly concentrated active-component preparations and may be used, for example, in quantities of about 2.5 to 5% by weight and, more particularly, in quantities of ca. 3 to 4% by weight, based on oil phase.

In practice, hydrophobicized lignite in particular is used as a fluid loss additive and, hence, in particular to form a dense coating in the form of a substantially liquid-impermeable film on the walls of the well. Suitable quantities are, for example, about 5 to 20 lb/bbl, preferably 5 to 10 lb/bbl and more particularly 5 to 8% by weight, based on the oil phase.

In drilling fluids of the type in question here, the thickener normally used is a cationically modified fine-particle bentonite which may be used in particular in quantities of ca. 8 to 10 and preferably 2 to 5 lb/bbl or in the range from 1 to 4% by weight, based on oil phase. The weighting agent normally used to establish the necessary pressure equilibrium is barite (BaSO₄), of which the quantities added are adapted to the particular conditions to be expected in the well. For example, the specific gravity of the drilling fluid can be increased by addition of barite to values of up to about 2.5 and preferably in the range from ca. 1.3 to 1.6. Another suitable weighting agent is calcium carbonate.

### EXAMPLES

### Example 1

To test the present technical teaching, drilling fluids with the following general composition were prepared:

| | | |
|---|---|---|
| oil phase¹⁾ | 173 | ml |
| water | 77 | ml |
| thickener²⁾ | 2 | g |
| emulsifier³⁾ | 8 | g |
| fatty acid⁴⁾ | 2 | g |
| Ca(OH)₂ | 2 | g |
| fluid loss additive⁵⁾ | 7 | g |
| barium sulfate | 327 | g |
| CaCl₂•2H₂O | 27 | g |

| | |
|---|---|
| oil-to-water ratio | 70:30 (v/v) |
| density | 14 lb/gal (1.7 g/l) |

¹⁾C₁₆₋₁₈-α-olefin, isomerized (Chevron); density at 20° C.: 0.785 g/cm³, Brookfield (RVT) viscosity at 20° C. 5.5 mPa · s
²⁾modified organophilic bentonite, Geltone II (Baroid)
³⁾aminoamide
⁴⁾modified lignite dust, Duratone HT (Baroid)

The constituents were mixed in the following order in a Hamilton mixer: oil phase, water, thickener, emulsifier, lime, fluid loss additive, barium sulfate and then the calcium chloride and, optionally, a contaminant (RevDust). The additive according to the invention (APG carboxylate Plantapon LGC UP, Cognis; contains 30% by weight active substance) and a fatty acid mixture of 73% oleic acid, 8% linoleic acid and 19% unsaturated fatty acids were then added in quantities of 9 g and 2 g, respectively, after which the rheological characteristics of the fluids—plastic viscosity (PV), yield point (YP) and gel strength (gels 10″/′) after 10 seconds and 10 minutes—were determined with a Fann SR 12 rheometer (Fann). Electrical stability was also measured.

The drilling fluid was then tested in a Roller Oven (Baroid) for 16 hours at temperatures of 121° C. (after hot rolling=AHR and before hot rolling=BHR in the Table). The results are set out in Table 1; an invert drilling fluid with (B) and without (A) the additive according to the invention and the fatty acid mixture were tested. The additive according to the invention was added to the above general formulation in quantities of 9 g, the content of standard emulsifier being reduced to 0 g at the same time.

TABLE 1

| | | System No.: | | | |
|---|---|---|---|---|---|
| | | A | | B | |
| | | BHR | AHR | BHR | AHR |
| Hours rolled/aged | h | | 16 | | 16 |
| Hot roll temp. | ° F. | | 250 | | 250 |
| Static age temp. | ° F. | | — | | — |
| 600 rpm | sd | 67 | 66 | 82 | 69 |
| 300 rpm | | 40 | 40 | 49 | 39 |
| 200 rpm | | 31 | 30 | 39 | 30 |
| 100 rpm | | 21 | 21 | 27 | 20 |
| 6 rpm | | 7 | 8 | 9 | 8 |
| 3 rpm | | 6 | 7 | 8 | 7 |
| PV | cP | 27 | 26 | 33 | 30 |
| YP | lb/100 ft² | 13 | 14 | 16 | 9 |
| Gels 10″/10′ | lb/100 ft² | 6/7 | 6/7 | 8/11 | 7/8 |
| HTHP total | ml | | 1.8 | | 0.9 |
| HTHP oil | ml | | 1.8 | | 0.9 |
| HTHP Temp. | ° F. | | 250 | | 250 |

sd = scale divisions on the rheometer

It can be seen that the addition of the surfactant mixtures according to the invention leads to better filtrate values and to a lower YP after ageing of the drilling fluid.

### Example 2

The test series of Example 1 was repeated, except that the fluid was aged for 16 hours at a temperature of 300° F. The results for PV, YP and gels are set out in Table 2.

TABLE 2

| | | System No.: | | | |
|---|---|---|---|---|---|
| | | A | | B | |
| | | BHR | AHR | BHR | AHR |
| Hours rolled/aged | h | | 16 | | 16 |
| Hot roll temp. | ° F. | | 300 | | 300 |
| Static age temp. | ° F. | | — | | — |
| PV | cP | 26 | 27 | 31 | 29 |
| YP | lb/100 ft² | 14 | 15 | 9 | 11 |
| Gels 10″/10′ | lb/100 ft² | 6/8 | 6/7 | 5/8 | 6/7 |

Again, it can be seen that the YP of the drilling fluid containing the additive according to the invention is lower than that of the comparison fluid.

### Example 3

In another test, the invert drilling fluids were produced and tested for their rheological properties in the same way as in Example 1. On this occasion, however, salt water was also added in quantities of 35 g to determine the behavior of the drilling fluid in response to contamination. Drilling fluid A contained 8 g of the standard emulsifier; drilling fluid B instead contained 9 g of the Plantapon LGC UP according to the invention and 2 g of the same fatty acid mixture as in Example 1. The results are set out in Table 3.

TABLE 3

| | | System No.: | | | |
|---|---|---|---|---|---|
| | | A | | B | |
| | | BHR | AHR | BHR | AHR |
| Hours rolled/aged | h | | 16 | | 16 |
| Hot roll temp. | ° F. | | 250 | | 250 |
| Static age temp. | ° F. | | — | | — |
| PV | cP | 34 | 31 | 33 | 32 |
| YP | lb/100 ft² | 23 | 18 | 25 | 17 |
| Gels 10″/10′ | lb/100 ft² | 9/11 | 8/10 | 10/13 | 9/12 |

### Example 4

Invert drilling fluids were produced and tested in the same way as in Example 3, except that on this occasion 45 g of RevDust, a filter ash, were added. The results are set out in Table 4.

TABLE 4

| | | System No.: | | | |
|---|---|---|---|---|---|
| | | A | | B | |
| | | BHR | AHR | BHR | AHR |
| Hours rolled/aged | h | | 16 | | 16 |
| Hot roll temp. | ° F. | | 250 | | 250 |
| Static age temp. | ° F. | | — | | — |
| PV | cP | 50 | 52 | 56 | 64 |
| YP | lb/100 ft² | 36 | 31 | 50 | 28 |
| Gels 10″/10′ | lb/100 ft² | 13/32 | 12/20 | 22/33 | 8/14 |

### Example 5

Drilling fluids were produced in the same way as in Example 1, a pure APG and various quantities of the surfactant mixtures according to the invention being used in an addition to a standard emulsifier. The drilling fluids were free from the fatty acid mixtures of Example 1. System A contained 8 g of the standard emulsifier, B 8 g of an alkyl oligoglycoside (APG 600, Cognis) and systems C to E 8, 7 and 5 g of the surfactant mixture according to the invention. The results of the measurements are set out in Table 5.

TABLE 5

| | | A | | B | | C | | D | | E | |
|---|---|---|---|---|---|---|---|---|---|---|---|
| | | BHR | AHR | BHR | AHR | BHR | AHR | BHR | AHR | BHR | AHR |
| Hours rolled/aged | h | | 16 | | 16 | | 16 | | 16 | | 16 |
| Hot roll temp. | ° F. | | 250 | | 250 | | 250 | | 250 | | 250 |
| Static age temp. | ° F. | | | | | | | | | | |
| Electrical stab. | V | 320 | 260 | 270 | 360 | 210 | 200 | 200 | 210 | 190 | 290 |
| 600 rpm | sd | 65 | 61 | 55 | 58 | 76 | 77 | 71 | 73 | 73 | 75 |
| 300 rpm | | 39 | 35 | 28 | 30 | 46 | 49 | 41 | 45 | 44 | 46 |
| 200 rpm | | 30 | 26 | 20 | 22 | 36 | 39 | 32 | 35 | 35 | 36 |
| 100 rpm | | 20 | 17 | 11 | 13 | 27 | 29 | 21 | 24 | 26 | 26 |
| 6 rpm | | 6 | 5 | 2 | 3 | 13 | 13 | 9 | 10 | 13 | 12 |
| 3 rpm | | 5 | 4 | 1 | 2 | 10 | 12 | 8 | 9 | 11 | 11 |
| PV | cP | 26 | 26 | 27 | 28 | 30 | 28 | 30 | 28 | 29 | 29 |
| YP | lb/100 ft² | 13 | 9 | 1 | 2 | 16 | 21 | 11 | 17 | 15 | 17 |
| Gels 10″/10′ | lb/100 ft² | 6/7 | 4/6 | 2/5 | 3/5 | 10/19 | 11/17 | 11/25 | 11/22 | 10/19 | 10/15 |

sd = scale divisions on the rheometer

### Example 6

Three drilling fluids were produced as described in Example 1, mixtures of the surfactant mixture according to the invention with free fatty acids being tested as in Example 1. The quantity of the surfactant mixture according to the invention was varied between 7 g (A), 9 g (B) and 11 g (C). The fatty acid mixture was present in quantities of 2 g.

| | | A | | B | | C | |
|---|---|---|---|---|---|---|---|
| | | BHR | AHR | BHR | AHR | BHR | AHR |
| Hours rolled/aged | h | | 16 | | 16 | | 16 |
| Hot roll temp. | ° F. | | 250 | | 250 | | 250 |
| Static age temp. | ° F. | | | | | | |
| Electrical stab. | V | 300 | 230 | 340 | 270 | 410 | 300 |
| 600 rpm | sd | 84 | 71 | 82 | 69 | 73 | 70 |
| 300 rpm | | 51 | 41 | 49 | 39 | 44 | 40 |
| 200 rpm | | 41 | 32 | 39 | 30 | 35 | 31 |
| 100 rpm | | 29 | 22 | 27 | 20 | 24 | 21 |
| 6 rpm | | 10 | 8 | 9 | 8 | 7 | 7 |
| 3 rpm | | 9 | 7 | 8 | 7 | 6 | 6 |
| PV | cP | 33 | 30 | 33 | 30 | 29 | 30 |
| YP | lb/100 ft² | 18 | 11 | 16 | 9 | 15 | 10 |
| Gels 10″/10′ | lb/100 ft² | 10/13 | 8/9 | 8/11 | 7/8 | 6/9 | 6/9 |
| HTHP total | ml | | 1.6 | | 0.9 | | 0.8 |
| HTHP oil | ml | | 1.6 | | 0.9 | | 0.8 |
| HTHP temp. | ° F. | | 250 | | 250 | | 250 |

sd = scale divisions on the rheometer

1-13. (canceled)

14. A drilling fluid comprising a surfactant mixture comprised of the reaction product of at least one member selected from the group consisting of alkyl oligoglycosides and alkenyl oligoglycosides with at least one member selected from the group consisting of omega-halocarboxylic acids, salts of omega-halocarboxylic acids and esters of omega-halocarboxylic acids.

15. The drilling fluid claimed in claim 14, wherein the alkyl and alkenyl oligoglycosides comprise at least one member selected from the group consisting of oligoglycosides of formula:
RO-[G]ₚ (I)
in which R is an alkyl or alkenyl group containing 4 to 22 carbon atoms, G is a sugar unit containing 5 or 6 carbon atoms and p is a number of 1 to 10.

16. The drilling fluid of claim 14 wherein the omega-halocarboxylic acid salt comprises sodium monochloroacetate.

17. The drilling fluid of claim 14, wherein, the oligoglycoside is reacted with at least one of the omega-halocarboxylic acid, the omega-halocarboxylic acid salt and omega-halocarboxylic acid ester in a molar ratio of 1:0.5 to 1:3.5.

18. The drilling fluid of claim 14 which further comprises at least one aqueous phase and at least one nonaqueous phase with an emulsifier comprised of the reaction product.

19. The drilling fluid of claim 14, wherein, the surfactant mixture comprises an emulsifier which forms one of a water-in-oil or oil-in-water emulsion.

20. The drilling fluid of claim 14, comprising: a water-based emulsion wherein an oil phase comprises at least one ester of saturated or unsaturated, branched or unbranched monocarboxylic acids containing 1 to 24 carbon atoms with monohydric, linear or branched, saturated or unsaturated alcohols containing 1 to 24 carbon atoms.

21. The drilling fluid of claim 14 comprising: a water-based emulsion which contains an oil phase comprising at least one member selected from the group consisting of linear α-olefins, internal olefins and paraffins.

22. The drilling fluid of claim 14, wherein, the surfactant mixture is present in a quantity of 0.1% to 25% by weight based on the weight of the drilling fluid.

23. The drilling fluid of claim 14, which further comprises at least one C₆₋₂₂ free fatty acid in an amount of from 0.1% to 10% by weight of the drilling fluid.

24. The drilling fluid of claim 23, wherein the free fatty acid comprises a C₆₋₂₂ fatty acid.

25. A well servicing composition flowable and pumpable at 5 to 20° C. which comprises a continuous oil phase in admixture with a disperse aqueous phase (w/o invert type) an emulsifier comprising a surfactant mixture of claim 14 and dissolved and/or dispersed in the composition at least one auxiliary, selected from the group consisting of thickeners, fluid loss additives, wetting agents, fine-particle weighting agents, salts, alkali reserves and biocides.

26. The well servicing composition as claimed in claim 25, wherein the oil phase comprises at least one member selected from the group consisting of
(a) carboxylic acid esters of a formula:
R′—COO—R″ (II)
where R′ is a saturated or unsaturated, linear or branched C₅₋₂₃ aliphatic group and R″ is saturated or unsaturated, linear or branched, C₁₋₂₂ aliphatic group
(b) linear or branched C₈₋₃₀ olefins,
(c) water-insoluble, symmetrical or nonsymmetrical ethers of monohydric alcohols of natural or synthetic origin the monohydric alcohols containing from 1 to 24 carbon atoms,
(d) water-insoluble alcohols of formula:
R′″—OH (III)
where R′″ is a saturated, unsaturated, linear or branched C₈₋₂₄ alkyl group,
(e) carbonic acid diesters,
(f) paraffins, and
(g) acetals.

27. The drilling fluid of claim 14 wherein the surfactant mixture is present in a quantity of from 0.1% to 10% by weight, based on the weight of the drilling fluid.

28. The drilling fluid of claim 27 containing from 0.1% to 5% by weight of the surfactant mixture.

29. The drilling fluid of claim 14 wherein, the reaction product is formed by reacting an aqueous solution of at least one member selected from the group consisting of alkyl oligoglycosides and alkenyl oligoglycosides with at least one member selected from the group consisting of omega-halocarboxylic acids, salts of omega-halocarboxylic acids and esters of omega-halocarboxylic acids in the presence of alkali.

30. The drilling fluid of claim 23, wherein, the free fatty acid is present at from 0.3% to 5% by weight of the drilling fluid.

31. The drilling fluid of claim 30, wherein, the free fatty acid is present at from 1% to 5% by weight of the drilling fluid.

32. The drilling fluid of claim 23, wherein, the free fatty acid is present at from 1.5% to 6% by weight based on a weight of an oil phase.
